(19) United States
(12) Patent Application Publication
(10) Pub. No.: US 2017/0014901 A1
(43) Pub. Date: Jan. 19, 2017

(54) Wear Part with Hardfacing and Method of Making Same

(71) Applicant: Caterpillar Inc., Peoria, IL (US)

(72) Inventor: Kendall R. Powell, New Braunfels, TX (US)

(73) Assignee: CATERPILLAR INC., Peoria, IL (US)

(21) Appl. No.: 14/797,838

(22) Filed: Jul. 13, 2015

(51) Int. Cl. B22D 19/16; C21D 1/18; E02F 9/28; B22D 25/02; B32B 15/01; C21D 1/56; C21D 9/00

(52) U.S. Cl. CPC B22D 19/16; C21D 1/56; C21D 1/18; C21D 9/0068; B22D 25/02; B32B 15/013; E02F 9/2883; B33Y 10/00

(57) ABSTRACT

A wear part includes a body and a cladding layer. The body includes an outer surface. The body is made from a base material. The cladding layer is connected to the outer surface of the body. The cladding layer is constructed with the body via additive manufacturing. The cladding layer is made from a surfacing material which is harder than the base material.

### TECHNICAL FIELD

This patent disclosure relates generally to a wear part and, more particularly, to a wear part with hardfacing to increase its wear resistance.

### BACKGROUND

A surface of a component that contacts and undergoes relative motion with respect to another surface typically experiences wear that causes the progressive loss of material from the metal surface as a result of friction and contact between the interacting surfaces. Components, generally referred to as wear parts, can be positioned in areas of a machine that encounters recurring wear during normal use can be designed to be replaceable once the wear part suffers enough wear. Exemplary wear parts include undercarriage components of a machine, ground engaging tools, tunnel-boring machine (TBM) components, etc.

Excessive wear can lead to the premature failure of the wear part. Properties such as material hardness can help determine the wear resistance of the component. Hardness relates to the resistance of the material to scratching or abrasion. The higher the hardness of the material is, the greater its resistance to wear.

In some cases, after fabrication of a metal component, a heat treatment operation is performed to increase the hardness of the component surface in one or more locations that are expected to encounter wear. As a result of the heat treatment operation, a layer of material at the component surface has a higher hardness than the untreated body of the component. The increased hardness of the heat-treated layer of material can help improve the wear resistance of the part and can help prolong the useful life of the component.

Hardfacing involves the deposition of an additional material upon the base material of the component. The cladding layer of surfacing material, or hardfacing, can be selected and configured to be applied to a surface of a component to obtain one or more desired properties or dimensions, as opposed to being used to make a connecting joint. For example, a wear-resistant cladding layer of surfacing material can be deposited upon the exterior surface of a component to provide a hard surface in an area of the component expected to encounter wear during intended operation of the machine.

Hardfacing may be performed using a number of well known welding (or cladding) techniques. Three categories of such known techniques include: arc welding (or arc cladding), thermal spraying, and laser-based cladding. The surfacing material used for hardfacing is hard, but can be brittle and prone to developing cracks when applied in layers. The cracks can extend through all of the layers and into the base material.

U.S. Patent Application Publication No. US 2012/0258273 is entitled, “Hardfaced Wearpart Using Brazing and Associated Method and Assembly For Manufacturing,” and is directed to an article, such as a hardfaced wear part, that includes a substrate, a sheet metal shell connected to the substrate to define a cavity between the surface of the substrate and the shell, and a composite material filling the cavity and forming a coating on at least a portion of the surface of the substrate. The composite material includes a hard particulate material infiltrated with a metallic brazing material. The shell may be connected to the substrate by welding or brazing to the substrate, and may wear away during use. The shell and the substrate may be used as part of an assembly for producing the article. The shell is used as a mold for forming the composite material by filling the shell with the hard particulate material and subsequently infiltrating with the brazing material.

There is a continued need in the art to provide additional solutions to enhance the performance of components subjected to wear during use. For example, there is a continued need for wear parts which are produced readily and economically so as to enhance the durability and useful life of the wear part.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a wear part including a body and a cladding layer. The body includes an outer surface. The body is made from a base material. The cladding layer is connected to the outer surface of the body. The cladding layer is constructed with the body via additive manufacturing. The cladding layer is made from a surfacing material which is harder than the base material.

In yet another embodiment, a method of making a wear part is described. The method of making includes manufacturing a body using additive manufacturing. The body includes an outer surface. The body is made from a base material.

A cladding layer is manufactured using additive manufacturing. The cladding layer is made from a surfacing material. The surfacing material is harder than the base material. The cladding layer is manufactured with the manufacturing of the body via additive manufacturing such that the cladding layer is connected to the outer surface of the body.

Further and alternative aspects and features of the disclosed principles will be appreciated from the following detailed description and the accompanying drawings. As will be appreciated, the principles related to wear parts and methods of making wear parts disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side elevational view of an embodiment of a ripper shank assembly including an embodiment of a wear part in the form of a ripper tip constructed in accordance with principles of the present disclosure.

FIG. 2 is a front perspective view of the ripper tip of FIG. 1.

FIG. 3 is a rear perspective view of the ripper tip of FIG. 1.

FIG. 4 is an enlarged fragmentary, top plan view of a ground-engaging portion of the ripper tip including a distal end thereof.

FIG. 5 is an enlarged fragmentary, bottom plan view of the ground-engaging portion of the ripper tip.

FIG. 6 is an enlarged fragmentary, top plan view of another embodiment of a wear part constructed in accordance with principles of the present disclosure in the form of a ripper tip as in FIG. 4, but illustrating a cladding layer having a pattern segment.

FIG. 7 is a front perspective view of another embodiment of a wear part constructed in accordance with principles of the present disclosure in the form of a ripper tip as in FIG. 2, but illustrating a cladding layer that substantially encases a distal ground-engaging portion of the ripper tip.

FIG. 8 is a flowchart illustrating steps of an embodiment of a method of making a wear part following principles of the present disclosure.

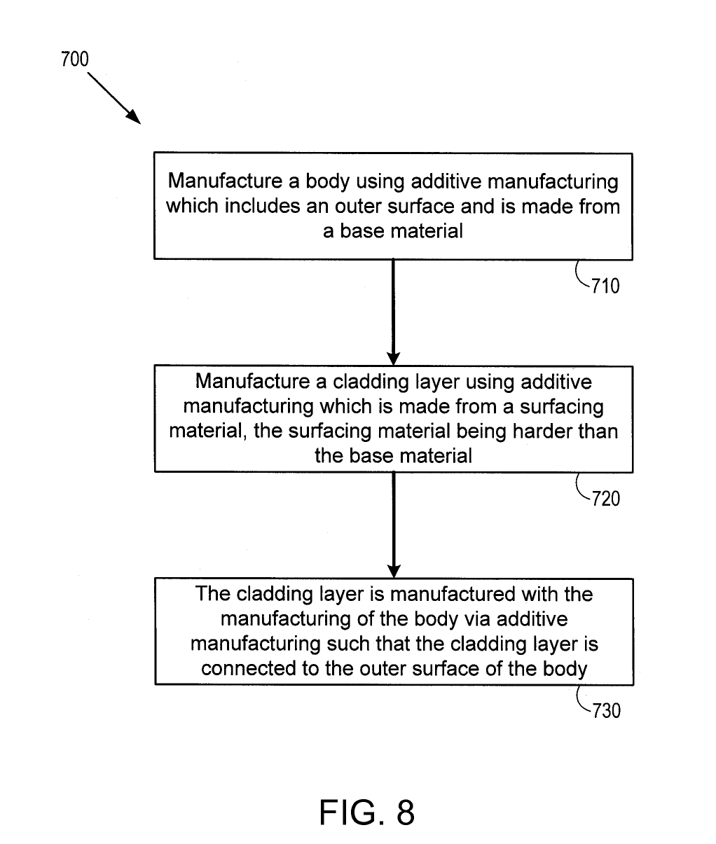

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides embodiments of a wear part and methods of making the same. In embodiments, the wear part is connected to any suitable work implement which is intended to experience wear during ordinary usage. Exemplary work implements include a ripper, a bucket, a blade, a shovel, a crusher, a grapple, or any other material moving device known in the art, for instance.

The work implement which includes a wear part constructed in accordance with principles of the present disclosure can be incorporated into any suitable machine. In embodiments, the machine can be any suitable machine for use with a wear part constructed in accordance with principles of the present disclosure. Examples of such machines include mobile or fixed machines used for construction, farming, mining, forestry, transportation, and other similar industries. In some embodiments, the machine can be an excavator, tractor, wheel loader, backhoe, crane, compactor, dozer, wheel tractor-scraper, material-handling machine, or any other suitable machine which includes a wear part.

Embodiments of a wear part constructed according to principles of the present disclosure can have a cladding layer, or hardfacing, which is placed in contacting relationship with an outer surface of the body using additive manufacturing techniques (also sometimes referred to as “additive layer manufacturing” or “3D printing” by those skilled in the art). In embodiments, the cladding layer is made from a surfacing material that is harder than the base material used to manufacture the body of the wear part. In embodiments, the base material is more ductile than the surfacing material is.

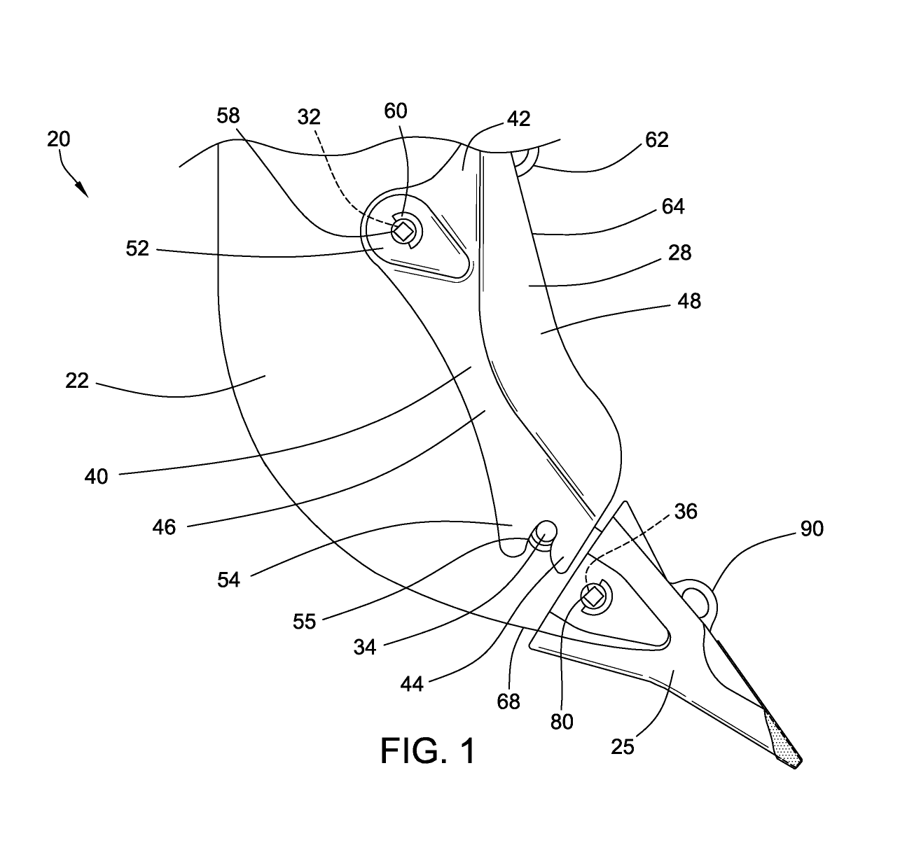

Turning now to the FIGURES, there is shown in FIG. 1 an exemplary embodiment of a ground-engaging tool in the form of a ripper shank assembly 20 constructed in accordance with principles of the present disclosure. The ripper shank assembly 20 can be used in any suitable machine. For example, in the operation of ground-engaging machinery, especially of the type known as track type tractors, it is a common practice to position the ripper shank assembly 20 on the machine such that it can be placed in engaging contact with the ground to penetrate and loosen the ground to aid its removal.

The ripper shank assembly 20 includes a ripper shank 22, a wear part constructed according to principles of the present disclosure in the form of a ripper tip 25, and a ripper shank protector 28. The ripper shank 22 can be configured to serve as the primary structural member of the ripper shank assembly 20. The ripper shank 22 can be constructed from any suitable material, such as, steel or cast iron, for example. In embodiments, the ripper shank 22 is configured such that it can to be mounted to a framework of the machine that is configured to be selectively raised and lowered via a power system of the machine to engage and penetrate the terrain. The ripper tip 25 can be moved through the terrain as the machine traverses over the terrain.

The ripper tip 25 and the ripper shank protector 28 can be configured to help shield portions of the ripper shank 22 from direct contact with terrain. The ripper tip 25 and the ripper shank protector 28 can be subjected to aggressive abrasion during the ripping operation. Accordingly, these parts can be configured as wear parts that are readily removed from the ripper shank 22 and replaced with a new replacement wear part without removing the ripper shank 22 from the element of the machine to which it is mounted.

The ripper shank 22 can include any suitable structural element configured to facilitate securing the ripper tip 25 and the ripper shank protector 28 to the ripper shank 22. For example, in the illustrated embodiment, the ripper shank 22 includes mounting projections 32, 34, 36 for attaching the ripper tip 25 and the ripper shank protector 28 to the ripper shank 22. In embodiments, the mounting projections 32, 34, 36 can have any suitable configuration, as will be appreciated by one skilled in the art.

As shown in FIG. 1, the ripper shank protector 28 is configured to mount to the ripper shank 22 above the ripper tip 25. The ripper shank protector 28 can be configured to help protect the ripper shank 22 from wear. The ripper shank protector 28 includes a protector body 40 with a proximal end 42 and a distal end 44. The ripper shank protector 28 can be made from any suitable material, such as, steel or cast iron, for example. In embodiments, the ripper shank protector 28 can be constructed according to principles of the present disclosure and include a cladding layer, or hardfacing, which is placed in contacting relationship with an outer surface of the protector body 40 using additive manufacturing techniques.

The protector body 40 is generally saddle-shaped and includes a pair of sides 46 (one of which is shown in FIG. 1) that are in lateral spaced relationship to each other and a central face 48 extending between the sides 46. A mounting cavity is defined between the sides 46 such that the ripper shank protector 28 can be mounted to the ripper shank 22 in wrapping relationship to a leading portion of the ripper shank 22. The mounting cavity of the ripper shank protector 28 can be configured to receive and mate with a leading portion of the ripper shank 22. In embodiments, the mounting cavity of the ripper shank protector 28 has a shape that substantially conforms to the leading portion of the ripper shank 22 which is disposed within the mounting cavity when the ripper shank protector 28 is mounted thereto.

In embodiments, the ripper shank protector 28 can be attached to the ripper shank 22 via any suitable mechanism. In the illustrated embodiment, each of the sidewalls or sides 46 of the ripper shank protector 28 includes a proximal mount 52 and a distal mount 54.

The distal mount 54 is constructed as a fork and defines an open-ended slot 55 configured to receive the mounting projection 34 therein. The proximal mount 52 can be configured to engage the mounting projection 32. A suitable rotating lock assembly 58, which is well known to one skilled in the art, can be placed within the proximal mount 52 to selectively secure the proximal mount 52 to the mounting projection 32. The proximal mount 52 can define a lock opening 60 that extends through the side 46 of the ripper shank protector 28. The lock opening 60 can be configured to permit the lock assembly 58 to selectively rotate between a locked position and an unlocked position. The other side 46 of the ripper shank protector 28 can have substantially the same configuration as the side 46 shown in FIG.

The ripper shank protector 28 can include a lift eye 62 (a portion of which is shown in FIG. 1, but which is readily understood by one skilled in the art) that is attached to a central ridge 64 of the central face 48 of the ripper shank protector 28. The lift eye 62 can be used to facilitate using a lifting apparatus (e.g., a hoist) to move the ripper shank protector 28, such as, during mounting the ripper shank protector 28 to, and removing it from, the ripper shank 16, for example.

Referring to FIG. 1, the ripper tip 25 is mounted to a distal end 68 of the ripper shank 22 and is disposed below the ripper shank protector 28. In embodiments, the ripper tip 25 can be attached to the ripper shank 22 via any suitable mechanism.

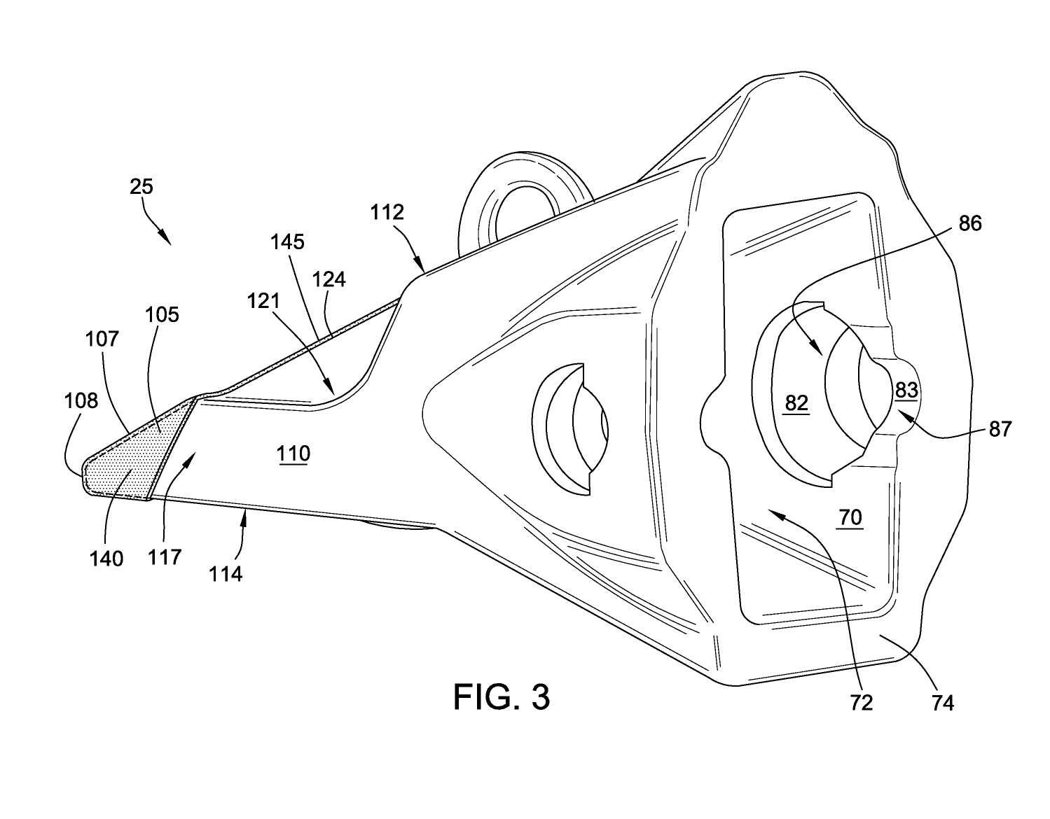

Referring to FIG. 3, the illustrated ripper tip 25 includes an internal surface 70 that defines an internal mounting cavity 72 extending inwardly from a proximal end 74 of the ripper tip 25. The internal mounting cavity 72 can be configured to receive and mate with the distal end 68 of the ripper shank 22. Accordingly, the ripper tip 25 can be mounted to the ripper shank 22 by disposing the distal end 68 of the ripper shank 22 within the internal mounting cavity 72 of the ripper tip 25 and fastening the ripper tip 25 in place (see also, FIG. 1).

Referring to FIG. 1, in embodiments, the ripper tip 25 can be removably secured to the ripper shank 22 via any suitable mechanism. In the illustrated embodiment, the ripper tip 25 is secured to the ripper shank via the mounting projection 36 and a suitable rotating lock assembly 80.

Referring to FIG. 3, the ripper tip 25 can include a lock cavity surface 82 and a slot surface 83 which defines a lock cavity 86 and a clearance slot 87, respectively. The lock cavity 86 and the clearance slot 87 are both in communication with the internal mounting cavity 72.

The clearance slot 87 is configured to accommodate the mounting projection 36 therethrough such that the ripper tip 25 can be inserted over the distal end 68 of the ripper shank 22. The ripper tip 25 can be disposed over the distal end 68 of the ripper shank 22 such that the mounting projection 36 is disposed within the lock cavity 86 for interengagement with the rotating lock assembly 80. The lock cavity 86 can be positioned such that the mounting projection 36 is substantially centrally aligned within the lock cavity 86 when the ripper tip 25 is in mating position on the distal end 68 of the ripper shank 22 (see also, FIG. 1).

Referring to FIG. 1, the lock cavity 86 can be configured to receive the rotating lock assembly 80 therein. The rotating lock assembly 80 is configured to be operable to selectively lock the ripper tip 25 to the ripper shank 22 via the mounting projection 36. The ripper tip 25 can have a similar mounting configuration on the other side thereof

The ripper tip 25 can include a lift eye 90. The lift eye 90 can be used to facilitate using a lifting apparatus (e.g., a hoist) to facilitate maneuvering the ripper tip 25, such as during mounting the ripper tip 25 to, and removing it from, the ripper shank 22, for example.

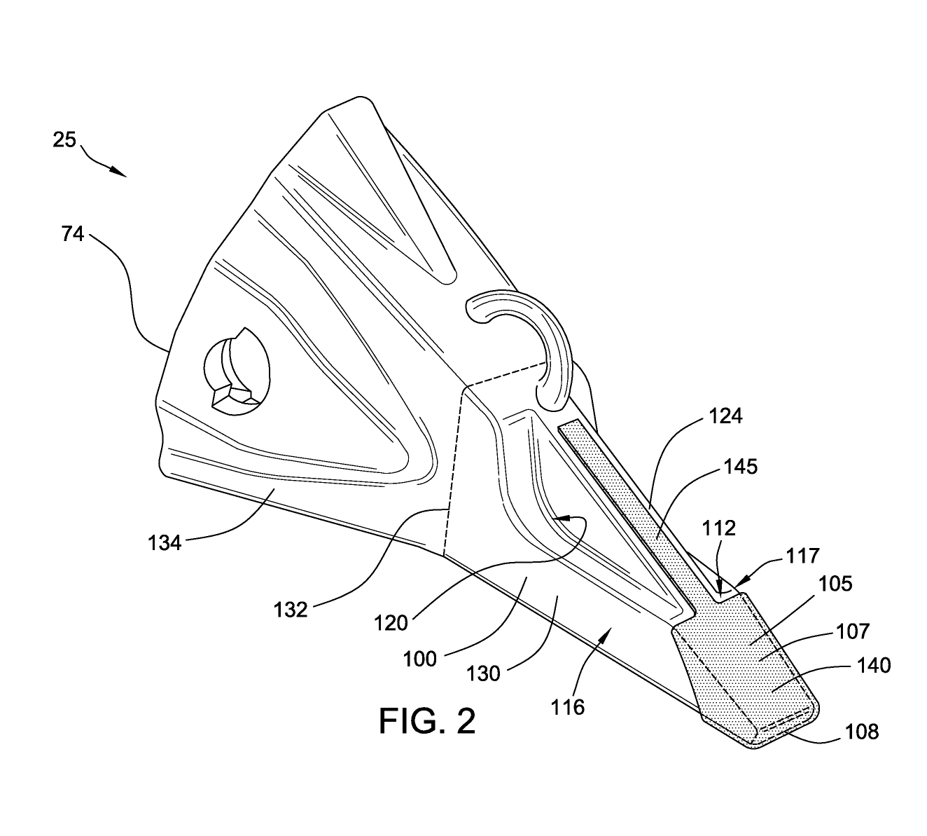

Referring to FIG. 2, the ripper tip 25 comprises a wear part constructed according to principles of the present disclosure. The ripper tip 25 includes a body 100 and a cladding layer 105. The illustrated ripper tip 25 comprises a ground engaging tip that includes a ground engaging portion 107 having a distal end 108.

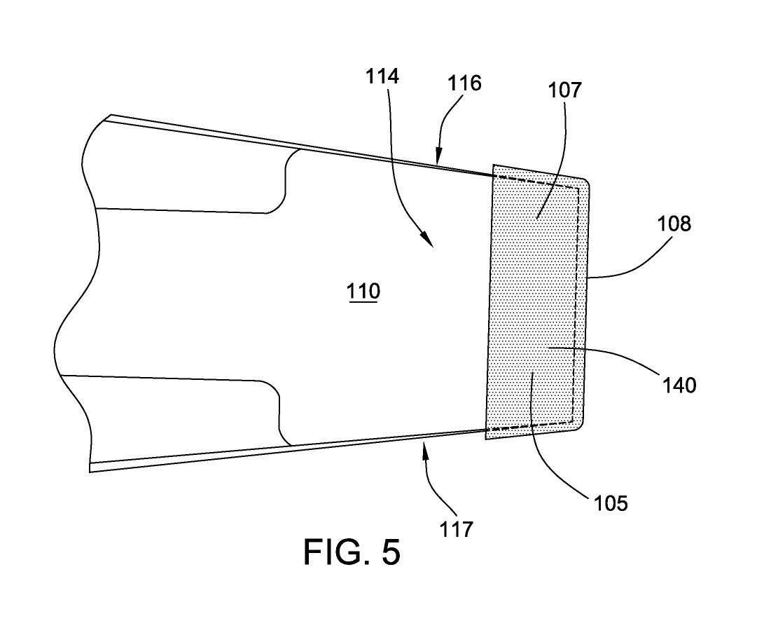

Referring to FIGS. 2-5, the body 100 includes an outer surface 110. The outer surface 110 of the body 100 comprises a closed surface including a top face 112, a bottom face 114, and a pair of side surfaces 116, 117. The top face 112 and the bottom face 114 extend longitudinally between the proximal end 74 and the distal end 108 of the wear part 25. The top face 112 and the bottom face 114 are in converging relationship to each other from the proximal end 74 to the distal end 108 such that the ground engaging portion 107 is generally wedge-shaped. The pair of side surfaces 116, 117 is in lateral spaced relationship to each other and extends between the top face 112 and the bottom face 114.

Referring to FIGS. 2 and 3, in embodiments, the outer surface 110 can include and/or define various other features. For example, the top face 112 can cooperate with the pair of side surfaces 116, 117 to respectively define a pair of recesses 120, 121 flanking a ridge portion 124 of the top face 112. The ridge portion 124 extends longitudinally along the ripper tip 25 and is disposed substantially along a lateral midline of the ripper tip 25.

The body 100 can be made via additive manufacturing. In the illustrated embodiment, the body 100 constitutes substantially the entire wear part body. In other embodiments, the body 100 is configured such that it comprises a portion of the wear part body that includes the cladding layer 105. For example, in embodiments, the body 100 constitutes a distal portion 130 of the ripper tip 25 as indicated by a broken line 132 in FIG. 2. A proximal portion 134 can be made using any suitable technique, such as by being cast, for example. The distal portion 130 and the proximal portion 134 can be secured together using any suitable technique.

In embodiments, the base material used to make the body 100 via additive manufacturing can be any suitable material. In embodiments, the base material comprises a metal, such as a steel, for example. In embodiments, the base material can be any suitable material that is typically used for a wear part body of the particular type of wear component being made.

The cladding layer 105 is connected to the outer surface 110 of the body 100. In embodiments, the cladding layer 105 is manufactured with the manufacturing of the body 100 via additive manufacturing such that the cladding layer 105 is connected to the outer surface 110 of the body 100.

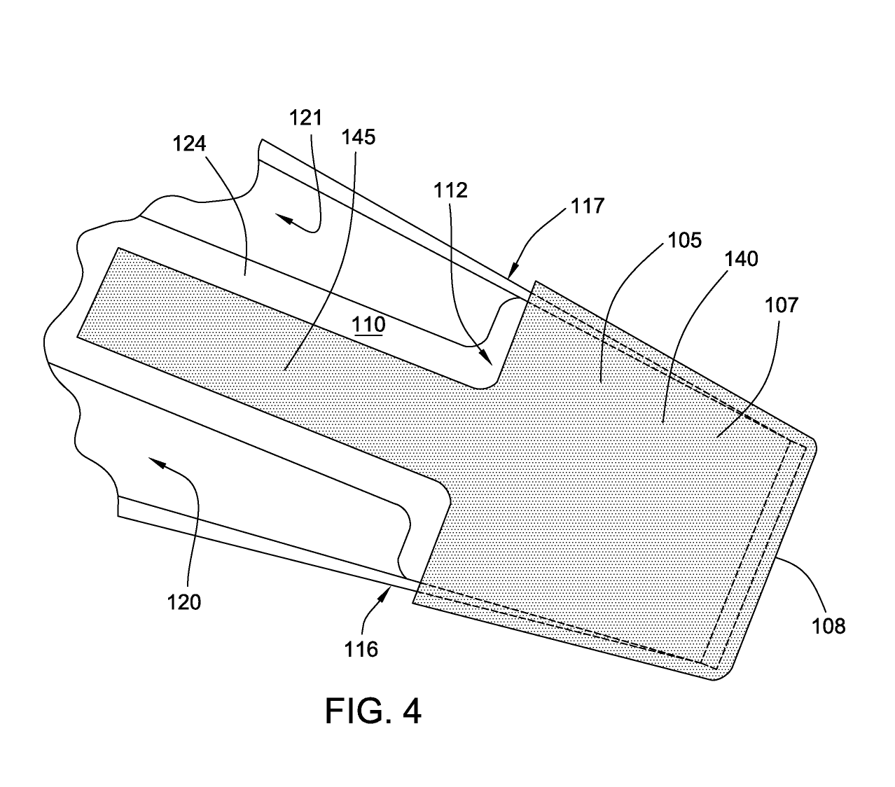

Referring to FIGS. 2-5, the cladding layer 105 of the illustrated embodiment is disposed at the ground engaging portion 107 and envelops the distal end 108. In embodiments, the cladding layer 105 can include a wrapping segment 140 that extends over at least three non-planar surfaces that are in adjoining relationship with each other. In embodiments, the wrapping segment 140 extends continuously over at least a portion of at least three of the top face 112, the bottom face 114, and the pair of side surfaces 116, 117. The wrapping segment 140 illustrated in FIGS. 2-5 circumscribes the body 100. In other embodiments, the wrapping segment 140 can have a different shape and/or size. For example, in embodiments, the wrapping segment 140 can envelop even more of the ground engaging portion 107. Referring to FIGS. 2 and 4, the cladding layer 105 includes a ridge segment 145 that extends longitudinally along the ridge portion 124 of the top face 112.

In embodiments, the cladding layer 105 can have any suitable shape and can cover a variety of locations of the body 100 which experience wear during the intended use of the wear part 25. In embodiments, the cladding layer 105 can be disposed at any suitable location of the body 100 for the purpose of reducing wear or loss of material through abrasion, impact, erosion, gulling, cavitation or some combination of these wear types. In embodiments, the cladding layer 105 includes one or more discontinuous segments.

The illustrated cladding layer 105 is approximately 5 mm thick. In embodiments, the thickness of the cladding layer 105 can be different. For example, in embodiments, the thickness of the cladding layer 105 can be in a range up to about 10 mm. In some embodiments, the thickness of the cladding layer 105 is in a range between about 1 mm and about 10 mm. In embodiments, the thickness of the cladding layer 105 is established according to the intended use and application of the implement to which the wear part 25 is mounted. Also, in embodiments, the thickness of the cladding layer 105 can vary from one position to another over the outer surface 110 of the body 100 which is covered by the cladding layer 105.

The cladding layer 105 is constructed with the body 100 via additive manufacturing. In embodiments, the surfacing material used to make the cladding layer 105 via additive manufacturing can be any suitable material. In embodiments, the surfacing material can be any suitable material that is typically used for hardfacing the particular type of wear component being made.

In embodiments, the surfacing material comprises an alloy, such as a tungsten carbide, for example. Depending upon the type of wear to be resisted, a variety of different alloy compositions can be used for the surfacing material, as will be appreciated by one skilled in the art. For example, in embodiments, a suitable alloy for use as the surfacing material from which the cladding layer 105 is made via additive manufacturing can include two or more of the following elements: carbon, manganese, silicon, chromium, molybdenum, tungsten, vanadium, titanium, nickel, cobalt, zirconium, boron, copper, aluminum, and niobium, among others.

Several material compositions that are suitable for use as the surfacing material from which the cladding layer 105 is made via additive manufacturing are commercially available from different manufacturers, as will be recognized by those skilled in the art. For instance, in embodiments, material compositions that comprise, or are equivalent to, Lincore® 33, Lincore® 55, Lincore® 60, etc. from The Lincoln Electric Company of Cleveland, Ohio; Stoody® 134, Stoody® 600, Stoody® 964, Stoody® 965, Stoody® 966, etc. from Stoody Company of Bowling Green, Kentucky; and Duraband®, Tuffband®, etc. from Postle Industries of Cleveland, Ohio, for example, may be suitable to be used as a surfacing material for the cladding layer 105.

In embodiments, the cladding layer 105 is made from a surfacing material which is harder than the base material of the body 100. In embodiments, the base material of the body 100 is more ductile than the surfacing material of the cladding layer 105. In embodiments, the surfacing material and the base material can each be processed so that they are in a form that is usable by the additive manufacturing equipment used to make the body 100 and the cladding layer 105 of the wear part 25. In embodiments, the base material and the surfacing material can each be provided as a supply of powder, or other suitable form, that is configured to be suitable for use with the additive manufacturing equipment being used to construct the wear part according to a method of making the wear part following principles of the present disclosure.

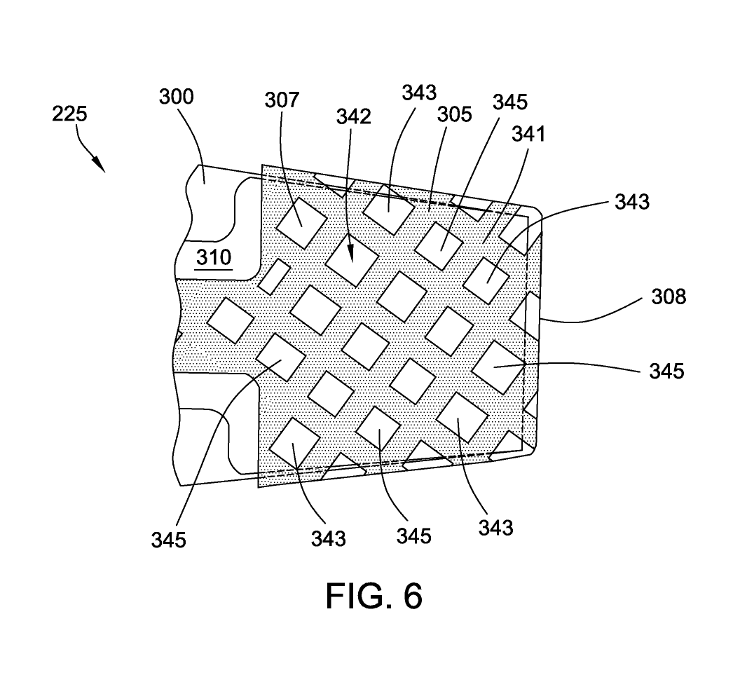

Referring to FIG. 6, another embodiment of a wear part in the form of a ripper tip 225 constructed in accordance with principles of the present disclosure is shown. The ripper tip 225 includes a body 300 and a cladding layer 305. The illustrated ripper tip 225 comprises a ground engaging tip that includes a ground engaging portion 307 having a distal end 308.

The body 300 includes an outer surface 310. The cladding layer 305 is connected to the outer surface 310 of the body 300. In embodiments, the cladding layer 305 is manufactured with the manufacturing of the body 300 via additive manufacturing such that the cladding layer 305 is connected to the outer surface 310 of the body 300.

In embodiments, the cladding layer 305 includes a pattern segment 341 that defines a void area 342 within the pattern segment 341. The outer surface 310 of the body 300 is exposed within the void area 342. The illustrated pattern segment 341 comprises a cross-hatch pattern that defines a void area 342 having a series of void openings 343, only a few of which are identified in FIG. 6 for the sake of clarity. The wear part 225 of FIG. 6 can be similar in other respects to the wear part 25 of FIGS. 2-5.

Referring to FIG. 6, in embodiments, the pattern segment 341 can comprise substantially the entire cladding layer 305. In other embodiments, the cladding layer 305 can include a pattern segment 341 that is only a portion of the entire cladding layer 305. In the illustrated embodiment, the pattern segment 341 comprises a cross-hatch pattern the covers substantially the entire cladding layer 305.

The pattern segment 341 is disposed over a portion of the body 300 having a body surface area. In embodiments, the void area 342 is twenty-five percent or more of the body surface area, and fifty percent or more of the body surface area in other embodiments. In those embodiments where the void area 342 comprises two or more discontinuous void openings 343, the area of all of the void openings 343 within the body surface area can be summed together to determine what percentage of the body surface area is occupied by openings to the outer surface 310 of the body 300.

In embodiments, the cladding layer 305 can be configured to define one or more debris channels 345 configured to retain dirt and debris generated during the intended use of the wear part. The built up dirt and debris trapped within the debris channels 345 can provide a replenishing wear surface that can help protect the underlying portions of the body from wear. In the illustrated embodiment, the cross-hatch pattern of the illustrated pattern segment 341 defines a series of regularly-spaced debris channels 345. Each void opening 343 is configured to serve as a debris channel 345, again only a few being designated as such in FIG. 6 for clarity purposes. The illustrated debris channels 345 are rectangular. In embodiments, the debris channels 345 can have a different shape and/or size.

In other embodiments, the pattern segment 341 can include variably-spaced debris channels. In yet other embodiments, the pattern segment 341 can include a recessed portion that has a reduced thickness relative to a surrounding portion of the cladding layer 305 that is configured to act as a debris channel 345 to trap debris therein which can serve as hardfacing.

In other embodiments, the pattern segment 341 can include a different pattern or a combination of patterns. For example, in embodiments, the pattern segment 341 comprises a plurality of circular protrusions. In embodiments, the pattern segment 341 comprises a plurality of longitudinally extending ribs. In some of such embodiments, the ribs are substantially axial and have a linear shape. In other embodiments, the ribs can be arcuate, and in other embodiments, the ribs can have a generally sinusoidal, wavy pattern.

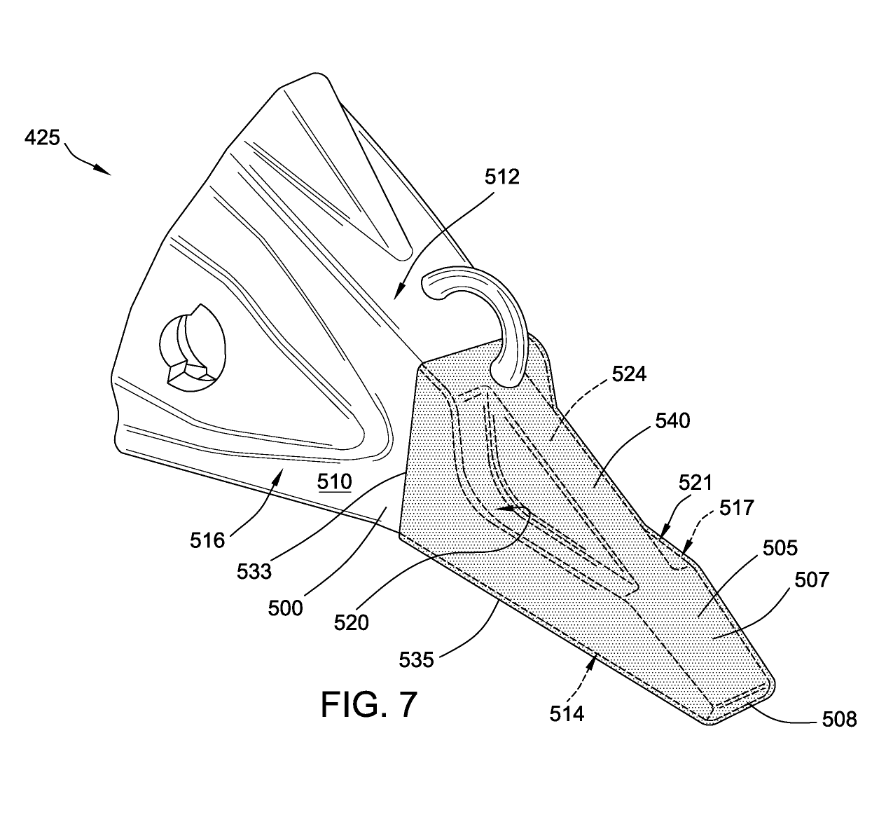

Referring to FIG. 7, another embodiment of a wear part in the form of a ripper tip 425 constructed in accordance with principles of the present disclosure is shown. The ripper tip 425 includes a body 500 and a cladding layer 505. The illustrated ripper tip 425 comprises a ground engaging tip that includes a ground engaging portion 507 having a distal end 508.

The body 500 includes an outer surface 510. The outer surface 510 includes a top face 512, a bottom face 514, and a pair of side surfaces 516, 517. The top face 512 and the pair of side surfaces 516, 517 cooperate together to respectively define a pair of recesses 520, 521 flanking a ridge portion 524 of the top face 512.

The cladding layer 505 is connected to the outer surface 510 of the body 500. In embodiments, the cladding layer 505 is manufactured with the manufacturing of the body 500 via additive manufacturing such that the cladding layer 505 is connected to the outer surface 510 of the body 500.

In embodiments, the cladding layer 505 includes a wrapping segment 540 that envelops the ground engaging portion 507 of the ripper tip 425 in an encapsulating manner. In the illustrated embodiment, all of the cladding layer 505 comprises the wrapping segment 540. The wrapping segment 540 illustrated in FIG. 7 envelops the ground engaging portion 507 from the distal end 508 to a longitudinal midline 533 such that the wrapping segment 540 envelops substantially all of the ground engaging portion 507 in a distal half of the ripper tip 425. In the illustrated embodiment, the wrapping segment 540 extends over the areas of the top face 512 and the pair of side surfaces 516, 517 that define the pair of recesses 520, 521. The illustrated wrapping segment also covers the bottom face 514 between the distal end 508 and the longitudinal midline 533. In other embodiments, the wrapping segment 540 can have a different size and/or shape.

Furthermore, although the illustrated embodiments describe wear parts in the form of a ripper tip, this is only exemplary, and in general, principles of the present disclosure can be applied to any type of wear part. It will be apparent to one skilled in the art that various aspects of the disclosed principles relating to wear parts can be used with a variety of different types of wear parts. Accordingly, one skilled in the art will understand that, in other embodiments, a wear part following principles of the present disclosure can include different types of wear parts and can take on different forms (e.g., TBM components; undercarriage components, such as, a grouser of a tack shoe; other ground engaging tools, such as a bucket tooth; etc.).

In embodiments of a method of making a wear part following principles of the present disclosure, the wear part is manufactured using additive manufacturing. Referring to FIG. 7, steps of an embodiment of a method 700 of making a wear part following principles of the present disclosure are shown. In embodiments, a method of making a wear part following principles of the present disclosure can be used to make any embodiment of a wear part according to principles discussed herein.

The illustrated method 700 of making a wear part includes manufacturing a body using additive manufacturing (step 710). The body includes an outer surface. The body is made from a base material. In embodiments, the body is manufactured from a suitable material, such as a metal alloy. In embodiments, the body is made from at least one of an alloy and a steel.

A cladding layer is manufactured using additive manufacturing (step 720). The cladding layer is made from a surfacing material. The surfacing material is harder than the base material.

The cladding layer is manufactured with the manufacturing of the body via additive manufacturing such that the cladding layer is connected to the outer surface of the body (step 730). In embodiments, any suitable additive manufacturing equipment can be used. For example, in embodiments, a production 3D printer commercially available from 3D Systems, Inc. of Rock Hill, S.C., can be used. In embodiments of a method of making a wear part following principles of the present disclosure, the body and the cladding layer are manufactured together via additive manufacturing in a continuous operation at substantially the same time.

Embodiments of a wear part constructed according to principles of the present disclosure can be made using additive manufacturing techniques. The cladding layer can be made from a surfacing material that is harder than the base material used to manufacture the body. The base material used for the body can be more ductile than the surfacing material used for the cladding layer. The cladding layer can be disposed over a coverage area that is oriented over a wear path associated with intended use of the wear part.

In embodiments of a method of making a wear part following principles of the present disclosure, the wear part comprises a ground engaging tip. The ground engaging tip includes a ground engaging portion having a distal end. The cladding layer is manufactured such that the cladding layer envelops the distal end.

In embodiments of a method of making a wear part following principles of the present disclosure, the body is manufactured such that the outer surface of the body comprises a closed surface including a top face, a bottom face, and a pair of side surfaces. The pair of side surfaces is in lateral spaced relationship to each other and extends between the top face and the bottom face. The cladding layer is manufactured such that the cladding layer includes a wrapping segment. The wrapping segment extends continuously over at least a portion of at least three of the top face, the bottom face, and the pair of side surfaces.

In embodiments of a method of making a wear part following principles of the present disclosure, the cladding layer is manufactured such that the cladding layer includes a pattern segment. The pattern segment defines a void area within the pattern segment. The outer surface of the body is exposed within the void area.

In embodiments of a method of making a wear part following principles of the present disclosure, the wear part is heat treated to increase a hardness value of a surface of a region of the wear part. In embodiments, heat treating the wear part includes heating the wear part, quenching the wear part after heating, and tempering the wear part after quenching. In embodiments, the wear part is heat treated such that the region of the body has a hardness of at least about 43 HRC (hardness in the Rockwell C scale). In embodiments, the wear part has a hardness in a range between about 43 HRC and about 60 HRC.

In embodiments, the heat treating conditions and process parameters are controlled to reduce the propensity of propagate any cracks that may be present in the cladding layer. In embodiments, the heat treating process is designed such that a temperature change of the wear part during quench is below a temperature change that will cause a crack in the cladding layer to be created and/or to propagate. In embodiments, quenching the wear part occurs in a bath of fluid (e.g., water or oil) maintained at a desired temperature of the bath and occurs for a predetermined amount of time to reach a desired residual temperature of the wear part after quenching. In embodiments, the residual temperature is controlled so as to reduce the likelihood of a crack developing or propagating the cladding layer.

In embodiments, the wear part is tempered by placing the wear part in a tempering furnace maintained at a predetermined temperature for a predetermined amount of time. After tempering, the wear part can be cooled to room temperature in air. In general, the process conditions employed during heat treatment depend upon the type of body material that is used for the body.

### Industrial Applicability

The industrial applicability of the embodiments of a wear part and a method of making the same as described herein will be readily appreciated from the foregoing discussion. At least one embodiment of a wear part constructed according to principles of the present disclosure can be used in a machine to help operate the machine with an improved lifespan relative to a wear part which does not include a cladding layer as described herein. Embodiments of a wear part according to principles of the present disclosure may find potential application in any suitable machine.

Embodiments of a wear part constructed according to principles of the present disclosure can have a cladding layer configured to help protect the wear part from the deleterious effects of wear during the intended use of the machine to which the wear part is mounted. Embodiments of a wear part constructed according to principles of the present disclosure can be made using additive manufacturing techniques. In embodiments, the cladding layer and the body of the wear part are manufactured together using an additive manufacturing process.

Advantageously, in embodiments, the cladding layer can be disposed over adjacent, non-planar surfaces to provide a wrapping or enveloping effect to enhance the protective aspect of the cladding layer. In embodiments, the cladding layer envelops a distal end of a ground-engaging portion of the wear component.

Advantageously, in embodiments, the cladding layer can include a pattern segment which has a shape that is configured to define at least one debris channel therein that is configured to trap material dislodged during the operation of the machine. The trapped material can be compressed and act as a replenishing wear-resistant layer.

In embodiments, the configuration of the cladding layer and the techniques used for making the wear part can increase the useful life of the wear component, and, thus, the work implement to which the wear part is mounted. The cladding layer can help the wear part withstand the ablative nature of the material against which the wear part is placed in contact during the intended use of the machine to which it is mounted.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A wear part comprising:
a body, the body including an outer surface, the body being made from a base material;
a cladding layer, the cladding layer connected to the outer surface of the body, the cladding layer constructed with the body via additive manufacturing, the cladding layer made from a surfacing material, the surfacing material being harder than the base material.

2. The wear part according to claim 1, wherein the base material is more ductile than the surfacing material.

3. The wear part according to claim 2, wherein the base material comprises a metal.

4. The wear part according to claim 2, wherein the base material comprises a steel.

5. The wear part according to claim 2, wherein the surfacing material comprises an alloy.

6. The wear part according to claim 5, wherein the alloy comprises tungsten carbide.

7. The wear part according to claim 1, wherein the outer surface of the body comprises a closed surface including a top face, a bottom face, and a pair of side surfaces, the pair of side surfaces in lateral spaced relationship to each other and extending between the top face and the bottom face, and wherein the cladding layer includes a wrapping segment, the wrapping segment extending continuously over at least a portion of at least three of the top face, the bottom face, and the pair of side surfaces.

8. The wear part according to claim 7, wherein the wrapping segment circumscribes the body.

9. The wear part according to claim 7, wherein the wear part comprises a ground engaging tip, the ground engaging tip including a ground engaging portion having a distal end, the top face and the bottom face in converging relationship to each other at the distal end, and the wrapping segment is disposed at the ground engaging portion.

10. The wear part according to claim 9, wherein the cladding layer envelops the distal end.

11. The wear part according to claim 1, wherein the cladding layer includes a pattern segment, the pattern segment defining a void area within the pattern segment, the outer surface of the body being exposed within the void area.

12. The wear part according to claim 11, wherein the pattern segment comprises a cross-hatch pattern.

13. The wear part according to claim 11, wherein the pattern segment is disposed over a portion of the body having a body surface area, the void area being twenty-five percent or more of the body surface area.

14. A method of making a wear part, the method of making comprising:
manufacturing a body using additive manufacturing, the body including an outer surface, the body being made from a base material;
manufacturing a cladding layer using additive manufacturing, the cladding layer made from a surfacing material, the surfacing material being harder than the base material;
wherein the cladding layer is manufactured with the manufacturing of the body via additive manufacturing such that the cladding layer is connected to the outer surface of the body.

15. The method of making according to claim 14, further comprising:
heat treating the wear part to increase a hardness value of a surface of a region of the wear part.

16. The method of making according to claim 15, wherein heat treating the wear part includes heating the wear part, quenching the wear part after heating, and tempering the wear part after quenching.

17. The method of making according to claim 15, wherein the wear part is heat treated such that the region of the body has a hardness of at least about 43 HRC.

18. The method of making according to claim 14, wherein the wear part comprises a ground engaging tip, the ground engaging tip including a ground engaging portion having a distal end, and wherein the cladding layer is manufactured such that the cladding layer envelops the distal end.

19. The method of making according to claim 14, wherein the body is manufactured such that the outer surface of the body comprises a closed surface including a top face, a bottom face, and a pair of side surfaces, the pair of side surfaces in lateral spaced relationship to each other and extending between the top face and the bottom face, and wherein the cladding layer is manufactured such that the cladding layer includes a wrapping segment, the wrapping segment extending continuously over at least a portion of at least three of the top face, the bottom face, and the pair of side surfaces.

20. The method of making according to claim 14, where the cladding layer is manufactured such that the cladding layer includes a pattern segment, the pattern segment defining a void area within the pattern segment, the outer surface of the body being exposed within the void area.
